(19) United States
(12) Patent Application Publication
(10) Pub. No.: US 2018/0320729 A1
(43) Pub. Date: Nov. 8, 2018

(54) CARABINER SYSTEMS AND METHODS

(71) Applicants: Pete Gompert, Huntsville, UT (US); Paul Terry, Park City, UT (US); Brendan Perkins, Salt Lake City, UT (US)

(72) Inventors: Pete Gompert, Huntsville, UT (US); Paul Terry, Park City, UT (US); Brendan Perkins, Salt Lake City, UT (US)

(73) Assignee: Black Diamond Equipment, Ltd., Salt Lake City, UT (US)

(21) Appl. No.: 15/917,922

(22) Filed: Mar. 12, 2018

Related U.S. Application Data
(60) Provisional application No. 62/500,515, filed on May 3, 2017.

(51) Int. Cl. F16B 45/02

(52) U.S. Cl. CPC F16B 45/02

(57) ABSTRACT

The present invention relates a carabiner system including a frame and a gate. The frame includes an opening between a pivot region and a keyed region. The keyed region of the frame may be hookless. The gate is pivotably coupled to the frame across the opening to form a continuously enclosed inner region in the closed configuration. The gate is also pivotably coupled about the pivot region of the frame forming a gap between the gate and frame in an open configuration. The gate further includes a key-lock region, a gate region, and an attachment region which are integrally formed together without any type of coupling between regions. The gate region includes a plurality of elongated members between the key-lock region and attachment region. The plurality of elongated members may include non-circular cross sections and varying thicknesses and tolerances designed to optimize functionality, weight, and appearance.

### RELATED APPLICATIONS

This application claims priority to U.S. provisional application Ser. No. 62/500,515 filed May 3, 2017, the contents of which are incorporated by reference.

### FIELD OF THE INVENTION

The invention generally relates to mechanical coupling mechanisms such as carabiners, karabiners, and snap-hooks. In particular, the invention relates to an improved carabiner gate system and method of operation.

### BACKGROUND OF THE INVENTION

Carabiners, karabiners, snap-hooks, and releasable clamps are used in a variety of applications for releasably coupling objects to one another. For example, a rock climber may use one or more carabiners to releasably secure a rope to a protection device during vertical ascension. Carabiners generally include a frame, a gate, and a releasable gate closure mechanism. The gate is configured to releasably engage the frame so as to form a continuous inner region which can mechanically couple to one or more objects. The releasable gate closure mechanism is configured to allow the gate to be selectively pivoted with respect to the frame in order to facilitate addition or removal of items from the continuous inner region. The releasable gate closure mechanism simultaneously biases the gate toward a closed configuration with respect to the frame so as to maintain mechanical coupling of items within the continuous inner region. A wide variety of frame, gate, and biasing systems exist to specifically accommodate particular applications and/or manufacturing costs for the carabiner.

Wire-gate type carabiners represent a particular gate construction, biasing system, and gate-frame interface. Wire-gate carabiners utilize a substantially elongated, looped rigid wire member for the gate portion of the carabiner system. A wire member is substantially an elongated metal structure with a circular cross-sectional shape. In general, the lengthwise ends of the wire member gate are oppositely coupled to the frame such that the spring/rebound rigidity of the gate creates the automatic biasing mechanism. As the gate is selectively pivoted about the frame coupling point, the torsional and bending properties of the wire automatically generate a biasing force that mechanically urges the gate back toward the closed configuration. The frame includes a gate interface region which generally includes a hook over which the loop of the gate is configured to extend while in the closed configuration. The reliable positioning of the loop with respect to the hook significantly affects the structural ability of the carabiner to counteract shear forces. Due to the inherent minimal gate thickness, wire-gate type carabiners are usually lighter in overall weight compared to other carabiners. However, the unique requirements and limitations of the gate/frame interface have resulted in an inability to manufacture wire-gate type carabiners for certain applications.

A variety of specialized carabiner designs are configured to include specific mechanical characteristics that optimize particular functionalities. One type of specialized carabiner includes a hookless or keyed engagement coupling scheme between the gate and frame when in the closed configuration. This type of gate/frame engagement scheme optimizes the engagement and disengagement of the carabiner with particular items such as a bolt hanger or a non-sling protection device. However, structural modifications must be incorporated into the gate/frame interface to maintain the necessary reliable coupling between the gate and frame in the closed configuration. For example, some form of three-dimensional keyed interface must generally be incorporated to provide the necessary engagement between the gate and frame. The three-dimensional keyed interface increases the reliability of the coupling between the gate and frame without the introduction of a hook structure. Various problems exist with conventional hookless carabiners, including manufacturing cost, susceptibility to debris-related obstruction, durability, and weight.

Therefore, there is a need in the industry for a carabiner that overcomes the limitations of existing systems in a cost-efficient manner.

### SUMMARY OF THE INVENTION

The invention particularly relates to an improved carabiner gate system and method of operation. One embodiment of the present invention relates to a carabiner system including a frame and a gate. The frame includes an opening between a pivot region and a keyed region. The keyed region of the frame may be hookless. The gate is pivotably coupled to the frame across the opening to form a continuously enclosed inner region in the closed configuration. The gate is also pivotably coupled about the pivot region of the frame, forming a gap between the gate and frame in an open configuration. The gate further includes a key-lock region, a gate region, and an attachment region which are integrally formed together without any type of coupling between regions. The gate region includes a plurality of elongated members between the key-lock region and attachment region. The plurality of elongated members may include non-circular cross sections and varying thicknesses and tolerances designed to optimize functionality, weight, and appearance. Alternative embodiments include unique methods of operation and manufacturing.

Embodiments of the present invention represent a significant advance in the field of carabiner systems by combining the functional advantages of hookless coupling between the gate and frame with an optimal integral single component gate. Comparable conventional key-lock carabiner gates generally require multi component gate systems with compression couplings or internal springs. Embodiments of the present invention minimize gate components and avoid coupling weaknesses between gate regions by providing a unique integral gate shape that inherently includes the respective regions for spring biasing, gate structure, and releasable hookless frame coupling.

These and other features and advantages of the present invention will be set forth or will become more fully apparent in the description that follows and in the appended claims. The features and advantages may be realized and obtained by means of the instruments and combinations particularly pointed out in the appended claims. Furthermore, the features and advantages of the invention may be learned by the practice of the invention or will be obvious from the description, as set forth hereinafter.

### BRIEF DESCRIPTION OF THE DRAWINGS

The following description of the invention can be understood in light of the Figures, which illustrate specific aspects of the invention and are a part of the specification. Together with the following description, the Figures demonstrate and explain the principles of the invention. In the Figures, the physical dimensions may be exaggerated for clarity. The same reference numerals in different drawings represent the same element, and thus their descriptions will be omitted.

FIGS. 1A-C illustrate a perspective views of a carabiner system in closed and open configurations in accordance with embodiments of the present invention;

FIGS. 2A-D illustrate views of a carabiner gate in accordance with embodiments of the present invention; and

FIGS. 3A-C illustrate perspective views of a carabiner system in accordance with embodiments of the present invention.

### DETAILED DESCRIPTION OF THE INVENTION

The invention particularly relates to an improved carabiner gate system and method of operation. One embodiment of the present invention relates to a carabiner system including a frame and a gate. The frame includes an opening between a pivot region and a keyed region. The keyed region of the frame may be hookless. The gate is pivotably coupled to the frame across the opening to form a continuously enclosed inner region in the closed configuration. The gate is also pivotably coupled about the pivot region of the frame, forming a gap between the gate and frame in an open configuration. The gate further includes a key-lock region, a gate region, and an attachment region which are integrally formed together without any type of coupling between regions. The gate region includes a plurality of elongated members between the key-lock region and attachment region. The plurality of elongated members may include non-circular cross sections and varying thicknesses and tolerances designed to optimize functionality, weight, and appearance. Also, while embodiments are described in reference to a carabiner gate system, it will be appreciated that the teachings of the present invention are applicable to other areas including but not limited to methods of operation, methods of manufacturing, etc.

The following terms are defined as follows:

### Definitions

Integral—A plurality of regions formed together without any type of coupling therebetween. For example, a conventional paperclip has multiple parallel regions without any type of coupling therebetween.

Molded—a member being formed of a single three-dimensional mold. A molded Mar. 11, 2018 member may include specific sub-regions having particular shapes and functions. For example, a traditional paperclip is a molded metal structure that does not include any form of couplings between the regions.

Hookless—a type of carabiner-gate coupling that does not include any type of hook oriented toward the interior of the enclosed carabiner frame.

Wireless—a structure that is composed of one or more materials that does not include a metal wire.

Pivotably coupled—two components that are coupled in a manner that enables a pivotal movement therebetween.

Continuously enclosed region—a two-dimensional region which is enclosed within a substantially continuous structure.

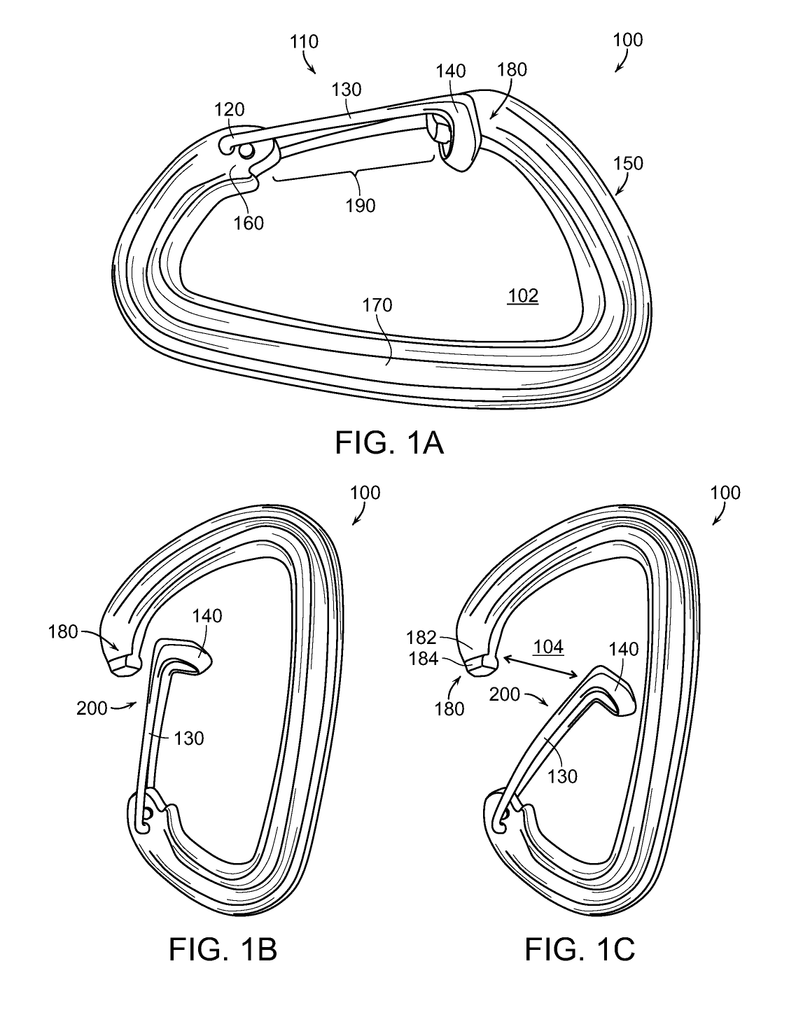

Reference is initially made to FIGS. 1A-C, which illustrate a carabiner system in the closed (FIG. 1A) and open configurations (FIGS. 1B-C), designated generally at 100. The system 100 includes frame 150 and a gate 110 which are pivotably intercoupled in both open and closed configurations. A continuously enclosed inner region 102 is formed within the frame 150 and gate 110 in the closed configuration (FIG. 1A). The continuously enclosed inner region 102 is a substantially two dimensional region enclosed by a mathematically continuous structure (gate and frame). A gap 104 is formed between a portion of the gate 110 and frame 150 in the open configuration (FIGS. 1B-C). The gap 104 may further be defined as a separation distance between the gate 110 and frame 150.

The frame 150 is a substantially C-shaped structure with a spine region 170 and an opening 190 between a pivot region 160 and a keyed region 180. The frame may be composed of one or more materials, including but not limited to metals and coatings. The frame may include various well known cross sectional shapes so as to optimize weight and strength characteristics, including but not limited to I-beam. It will be appreciated that the various carabiner gate systems discussed in this application may be practiced with a wide variety of carabiner frame structures, styles, and shapes. The keyed region 180 may include a flat parallel region 182 and an orthogonal expanded region 184 as shown in FIG. 1C. In preferred embodiments, neither the flat 182 nor expanded regions 184 include any form of hook facing the interior; therefore, the carabiner system 100 may be referred to as hookless. Rather, the combined shape of the flat and expanded regions 182, 184 form a specific male type coupler configured to interface with a correspondingly female shaped region on the gate (discussed below). The male-female hookless coupling between the gate 110 and the frame 150 creates the necessary operational closed-loop functional strengths in the closed configuration.

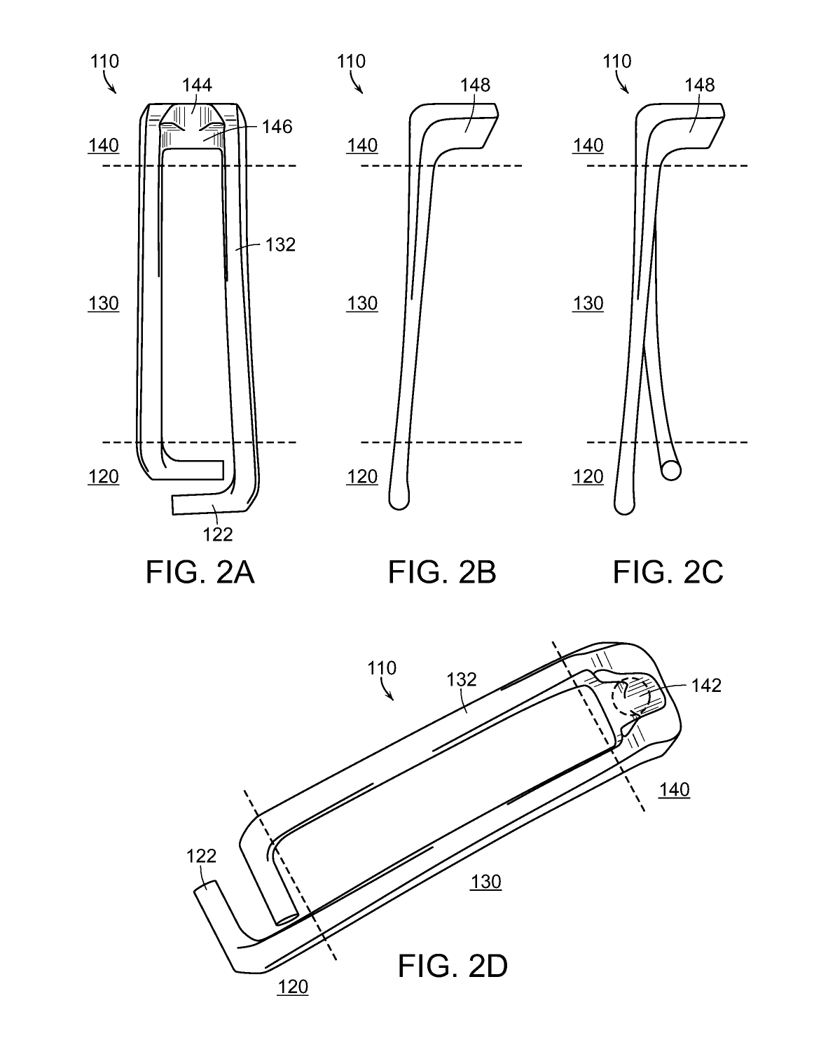

Reference is next made to FIGS. 2A-D, which illustrate perspective views of the gate, designated generally at 110. The gate 110 may include an attachment region 120, a gate region 130, and a key-lock region 140. The gate 110 is a critical component which may also be referred to as an integral, molded, and/or single-piece member because there are no couplings, unions, or discontinuities between the defined regions of the gate 110. This unique integral nature of the gate 110 provides numerous functional and manufacturing advantages over conventional multi-component or coupled carabiner gate systems. The attachment region 120 of the gate 110 is pivotably coupled to the pivot region 160 of the frame 150 via two substantially orthogonal rotating members 122. The orthogonal rotating members may include circular cross-sectional shapes and may extend into corresponding recesses on the pivot region 160 of the frame 150. The specific independent and offset positioning/orientation of the coupling between the attachment region 120 and the frame 150 in part creates the biasing system which urges the gate 110 towards the closed configuration with respect to the frame 150. The urging of the gate 110 towards the closed configuration may also be described as generating a biasing force which corresponds to the gap 104 distance between the gate 110 and the frame 150. The biasing force may also correspond to the composition and shape of the gate 110, which include a metal material shaped to create the malleable compliant spring functionalities. It is important to note that the composition and shape of the entire gate 110 may contribute to the biasing force which urges the gate 110 toward the closed configuration with respect to the frame 150. The gate region 130 may include two elongated members 132 as shown in the illustrated embodiments. The elongated members may include non-circular cross-sectional shaped regions and/or discontinuous thickness regions. In particular, the elongated members 132 may include oval, rectangular, and/or other non-circular cross-sectional shapes between the attachment region 120 and the key-lock region 140. Likewise, portions of the gate region 130 may include increased or decreased (discontinuous) thicknesses or densities so as to optimize structural integrity, user operation, and/or biasing. For example, high stress regions may be thicker than low stress areas to facilitate durability and operation. The key-lock region 140 includes a first smaller recess 144 and a second larger recess 146 corresponding to the keyed region of the frame (See FIG. 2A). The first smaller recess 144 and second larger recess 146 may also be described as defining a partially enclosed three dimensional concave region 142 (See FIG. 2D). The illustrated key-lock region 140 includes an externally defined orthogonal substantially rectangular U-shaped region between the elongated members of the gate region (FIGS. 2B-D). The external U-shaped region defines the first smaller recess 144 corresponding to the flat region 182 of the keyed region 180 of the frame 150 and the second larger recess 146 corresponding to the expanded region 184 of the keyed region 180 of the frame 150.

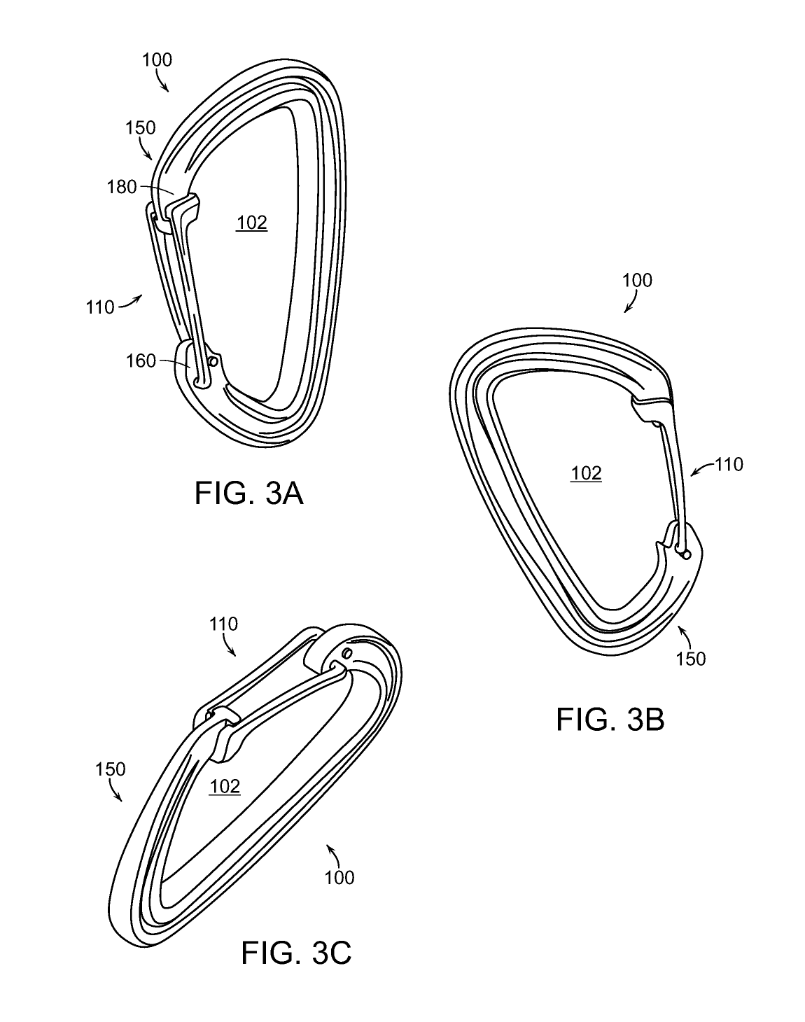

Reference is next made to FIGS. 3A-C, which illustrate alternative perspective views of the carabiner system in the closed configuration, designated generally at 100.

In operation, a user may selectively transition the carabiner system 100 from the biased default closed configuration (FIG. 1A) to the open configuration (FIG. 1B-C) by continuously exerting an opening force 200 (FIGS. 1B-C) upon the gate 110 with respect to the frame 150. The opening force 200 must exceed the biasing force of the biasing system discussed above. In addition, the opening force 200 must be maintained in order to maintain the open configuration of the carabiner system 100. Upon removal of the opening force 200, the gate 110 will pivot about the pivot region 160 of the frame 150 such that the key-lock region 140 couples with the keyed region 180 of the frame 150, thereby reengaging the closed configuration. The coupling of the key-lock region 140 with the keyed region 180 may further include coupling the first smaller recess 144 over the flat parallel region 182 and coupling the second larger recess 146 over the expanded region 184. Alternatively, the coupling of the key-lock region 140 with the keyed region 180 may be described as coupling the male keyed region 180 within the female partially enclosed region 142 of the gate 110.

It should be noted that various alternative system designs may be practiced in accordance with the present invention, including one or more portions or concepts of the embodiment illustrated in FIG. 1 or described above. Various other embodiments have been contemplated, including combinations in whole or in part of the embodiments described above.

What is claimed is:

1. A carabiner system comprising:
a frame including an opening between a pivot region and a keyed region;
a gate pivotably coupled to the frame across the opening, wherein the gate and frame form a continuously enclosed inner region in a closed configuration, and wherein the gate is pivotably rotated about the pivot region forming a gap between the gate and frame in the open configuration, and wherein the gate further includes a key-lock region, a gate region, and an attachment region;
a gate biasing system between the pivot region of the frame and the attachment region of the gate, wherein the gate biasing system biases the key-lock region of the gate toward the keyed region of the frame and the closed configuration;
wherein the closed configuration includes a coupling between the key-lock region of the gate and the keyed region of the frame in the closed configuration;
wherein the gate region of the gate includes a plurality of independent elongated members extending between the key-lock region and the attachment region;
wherein the attachment region is pivotably coupled to the pivot region of the frame in both the open and closed configurations;
wherein the key-lock region includes a partially enclosed concave region corresponding in shape to the keyed region of the frame; and
wherein the key-lock region, gate region, and attachment region of the gate are integral.

2. The carabiner system of claim 1, wherein the gate is wireless.

3. The carabiner system of claim 1, wherein the elongated members include only non-circular cross-sectional regions.

4. The carabiner system of claim 1, wherein the regions of the gate are molded.

5. The carabiner system of claim 1, wherein keyed region of the frame is hookless.

6. The carabiner system of claim 1, wherein the coupling between the key-lock region and the keyed region in the closed configuration includes a male-female coupling.

7. The carabiner system of claim 1, wherein the plurality of elongated members of the gate region include regions of variable thicknesses.

8. The carabiner system of claim 1, wherein the key-lock region of the gate includes an external substantially rectangular shape.

9. The carabiner system of claim 1, wherein the key-lock region of the gate includes a first smaller opening and a second larger opening, and wherein the first and second openings correspond in shape to the keyed region of the frame.

10. The carabiner system of claim 9, wherein the first smaller opening is distal to the gate region of the gate with respect to the second larger opening.

11. The carabiner system of claim 1, wherein the attachment region of the gate includes two substantially orthogonal regions coupled to the pivot region of the frame.

12. The carabiner system of claim 11, wherein the two substantially orthogonal regions are substantially orthogonal to the elongated members.

13. The carabiner system of claim 12, wherein the pivotable coupling between the attachment region and the pivot region includes coupling the substantially orthogonal regions of the gate within a plurality of recesses of the frame.

14. The carabiner system of claim 13, wherein the plurality of recesses are offset and disposed on the attachment region of the frame.

15. The carabiner system of claim 1, wherein the gate is substantially composed of a single material.

16. The carabiner system of claim 1, wherein the attachment, gate, and key-lock regions of the gate are inter-molded without compression coupling.

17. The carabiner system of claim 1, wherein the gate biasing system is configured to generate a biasing force urging the gate toward the closed configuration.

18. The carabiner system of claim 17, wherein the biasing force corresponds to a distance between the key-lock region of the gate and the keyed region of the frame.

19. A carabiner system comprising:
a frame including an opening between a pivot region and a keyed region;
a gate pivotably coupled to the frame across the opening, wherein the gate and frame form a continuously enclosed inner region in a closed configuration, and wherein the gate is pivotably rotated about the pivot region forming a gap between the gate and frame in the open configuration, and wherein the gate further includes a key-lock region, a gate region, and an attachment region;
a gate biasing system between the pivot region of the frame and the attachment region of the gate, wherein the gate biasing system biases the key-lock region of the gate toward the keyed region of the frame and the closed configuration;
wherein the closed configuration includes a coupling between the key-lock region of the gate and the keyed region of the frame in the closed configuration;
wherein the gate region of the gate includes a plurality of independent elongated members extending between the key-lock region and the attachment region;
wherein the attachment region is pivotably coupled to the pivot region of the frame in both the open and closed configurations;
wherein the key-lock region includes a partially enclosed concave region corresponding in shape to the keyed region of the frame, and wherein the key-lock region is hookless; and
wherein the key-lock region, gate region, and attachment region of the gate are integral and molded.

20. A carabiner system comprising:
a frame including an opening between a pivot region and a keyed region;
a gate pivotably coupled to the frame across the opening, wherein the gate and frame form a continuously enclosed inner region in a closed configuration, and wherein the gate is pivotably rotated about the pivot region forming a gap between the gate and frame in the open configuration, and wherein the gate further includes a key-lock region, a gate region, and an attachment region;
a gate biasing system between the pivot region of the frame and the attachment region of the gate, wherein the gate biasing system biases the key-lock region of the gate toward the keyed region of the frame and the closed configuration;
wherein the closed configuration includes a coupling between the key-lock region of the gate and the keyed region of the frame in the closed configuration;
wherein the gate region of the gate includes a plurality of independent elongated members extending between the key-lock region and the attachment region, wherein the elongated members include only non-circular cross-sectional regions, and wherein the elongated members include substantially variable thicknesses;
wherein the attachment region is pivotably coupled to the pivot region of the frame in both the open and closed configurations;
wherein the key-lock region includes a partially enclosed concave region corresponding in shape to the keyed region of the frame; and
wherein the key-lock region, gate region, and attachment region of the gate are integral.
